(19) United States
(12) Patent Application Publication
(10) Pub. No.: US 2024/0367307 A1
(43) Pub. Date: Nov. 7, 2024

(54) DURABLE SMOOTHING TROWEL

(71) Applicant: NELA GMBH, Remscheid (DE)

(72) Inventor: FRANK FREUDENREICH, REMSCHEID (DE)

(21) Appl. No.: 18/574,012

(22) PCT Filed: Jun. 23, 2022
(86) PCT No.: PCT/EP2022/000058

§ 371 Date: Dec. 23, 2023

(30) Foreign Application Priority Data
Jun. 23, 2021 (EP) 21000163.2

(51) Int. Cl. B25G 3/34; E04F 21/16; E04G 21/20

(52) U.S. Cl. CPC B25G 3/34; E04F 21/161; E04G 21/201

(57) ABSTRACT

The present invention relates to a tool which can be used to spread and smooth building materials, especially plaster and mortar. The present invention relates in particular to a smoothing trowel (10) which comprises a smoothing board (20) and a handle (30) and in which a grip holder (40) connects the handle (30) to the smoothing board (20), the grip holder (40) being connected to the smoothing board (20) by means of a large number of bolts (50), characterized in that holes (60) are provided in the smoothing board (20) and the bolts (50) are introduced into these holes (60).

### FIELD OF THE INVENTION

The present invention relates to a tool which can be used for spreading and smoothing building materials, in particular plaster and mortar. It is typically used for plastering. The tool is generally referred to here as a smoothing trowel. The invention also relates to spatulas, in particular also skimming spatulas, painters' spatulas and filler spatulas, and also in individual cases squeegees. The invention also relates to corner trowels, inside corner trowels and outside corner trowels, mortar trowels and pointed trowels, in a toothed and non-toothed version respectively.

### BACKGROUND OF THE INVENTION

The utility model DE 1 754 183 discloses a smoothing trowel, where the main elements are the trowel board, a grip support and the handle. The grip support is attached to a bar which stabilizes the trowel board. As disclosed in the utility model, it may be advantageous to manufacture all three parts in one piece from plastic. This also avoids the difficulty of forming a reliable connection, as the mechanical stress on the trowels and contact with mortar can weaken connections over time.

The published application 1 684 410 discloses a bricklayer's trowel with a solder connection between the trowel board and the handle support. The solder connection is intended to improve the strength of the connection between the handle and the trowel board. The solder is inserted into holes in the sole plate of the handle, which are additionally provided with widened parts at the end facing the trowel board. The solution may have proved successful for various trowels. However, it seems desirable to be able to offer alternatives to the solder connection, at least in order to have more freedom with regard to the configuration and choice of material for the grip support and trowel board.

The published application 25 40 885 discloses a smoothing trowel or a “smoothing surface” for plastering with a displaceable and replaceable handle. For this purpose, a guide rail is provided on the trowel board to which the handle is attached. The guide rail is welded to the trowel board which is made of steel.

The patent specification DE 3639978 discloses a bricklayer's trowel in which the handle is arranged behind the trowel board and is connected to the trowel board by a curved tube piece, the so-called tang. The attachment between the tang and the trowel board is meant to be formed by welding. This construction may produce a very durable connection but it is less suitable for other trowel shapes, for example those with the handle above the center of the board.

U.S. Pat. No. 9,784,000 discloses that bolts can be welded onto the upper side of the trowel board and a handle can be attached by way of these bolts.

The invention aims to overcome the disadvantages of the prior art. It is intended to provide a durable and robust smoothing trowel. It is also intended that the latter can be produced efficiently.

This problem is solved by a smoothing trowel according to claim 1.

Advantageous further embodiments are defined in the subclaims. These and further advantages can also be achieved by a method according to claims 8 to 14.

In the context of this invention, a “smoothing trowel” is also understood as a term for denoting related tools which are used for spreading building material, in particular those mentioned above by way of example with typical names. A smoothing trowel comprises at least one smoothing board and a handle. The smoothing board is generally an entirely flat or mostly flat surface, so that it can be used over the entire surface for smoothing in one plane. Exceptions are corner trowels for inner or outer corners/edges, where the smoothing board is curved so that both main working surfaces are at a 90° degree angle to one another.

A grip holder is intended to connect the handle to the smoothing board. The grip holder can be a separate component, alternatively it could be configured in one piece with the handle or with the smoothing board. The grip holder can preferably be made of metal, for example of steel, stainless steel or aluminum. It is particularly suitable to manufacture the grip holder as a cast component, preferably as a die-cast aluminum component. The grip holder could also be made of plastic, including by a process of injection molding.

The grip holder is to be connected to the smoothing board by a plurality of bolts. A plurality means here at least one bolt, usually at least two bolts and often between 4 and 10 bolts are used. Advantageously, the bolts are made of metal, for example steel, stainless steel or aluminum. A metal that can be easily welded is advantageous. It is also possible to weld the bolts to the grip holder. It can also be advantageous for the bolts to be screwed together. It can be advantageous to select the bolt material such that a press-fit connection can be formed.

It is advantageous if the majority of bolts or even all the bolts have the same diameter. This ensures that the smoothing trowel has an attractive appearance and simplifies the manufacture. Trowels can be produced in which the first and the last bolts of a connecting row of bolts are thicker than the other bolts. As the first and last bolts are subjected to higher loads than the other bolts, this can be advantageous. However, the present invention allows a secure and durable connection without having to choose a thicker first and last bolt.

According to the invention, recesses should be provided in the smoothing board. These recesses can be round holes for example. The bolts are inserted into these recesses. This means that bolts do not sit on the smoothing board, but are guided at least partly through the smoothing board. This type of connection geometry produces a stronger and more durable connection than the usual connections with bolts. A smoothing trowel is often used for several years, sometimes for even more than a decade. It is exposed to high mechanical stresses, in particular because at least the smoothing board typically has a certain degree of elasticity. It is also exposed to chemical stresses, in particular when it comes into contact with alkaline mortar or plaster.

It is advantageous if the bolts are welded to the smoothing board. This should include at least some of the number of bolts, preferably all. It has proved to be particularly advantageous to provide these weld joints on the working side of the trowel board and/or in the region of the recesses (i.e. between the working side and the opposite upper side of the smoothing trowel). It may be appropriate to provide weld joints on the working side of the smoothing board or to provide weld joints in the area of the recesses or to provide weld joints on the working side of the smoothing board and in the area of the recesses. Individual weld joints or all weld joints can be positioned in this way respectively.

This approach is associated with certain challenges, as the smoothness of the board then needs to be restored. At the same time however, it has been shown that such a connection is particularly secure and durable, and also favorable in terms of the manufacturing process.

Laser welding is particularly suitable for connecting the bolts to the smoothing plate, also known as laser beam welding. It can be used as heat conduction welding or deep penetration welding. In individual cases, it can be combined with other welding, joining or bonding techniques. Preferably, the connection is formed solely by laser welding. Preferably, no welding filler is used.

It has proven to be advantageous to manufacture the smoothing plate from chromium-molybdenum steel. It is generally advantageous, to make the smoothing board from steel. Torsion-resistant steels are particularly suitable for this purpose. However, these steels also mean that high forces act on the handle and thus the grip holder. It should also be taken into consideration that chromium-molybdenum steel in particular is brittle. A high thermal or mechanical load during the manufacture of the connection between the smoothing board and grip holder therefore needs to be avoided. This is achieved in particular by the present invention. Chromium-molybdenum steel is also used here as a generic term for alloys which contain additional (smaller) materials, in particular it is advantageous if the alloy contains nickel.

It is useful if the grip holder comprises a grip shoe, a grip shaft and a grip core. The latter can each be configured as separate components or the grip holder can be made in one piece. The connection to the smoothing board is established via the grip shoe. The grip shoe can be cuboid for example and have a flat surface on its underside facing away from the grip shaft for contacting and connecting with the smoothing board.

The grip shaft is used for connecting the grip shoe and grip core. It extends substantially perpendicular to the contact surface of the grip shoe, i.e. substantially perpendicular to the smoothing board when assembled.

The grip core extends typically substantially parallel to the smoothing board. Typically, the grip core is surrounded by a handle piece. The handle piece can be configured to be ergonomic. It is often made of plastic, but can also be made of cork for example. The handle piece can be configured in one piece with the grip core, however a removable and if necessary also a replaceable handle piece is advantageous. The handle piece can then be attached to the grip core and joined to it, for example wedged or glued or even screwed.

It is advantageous if the bolts are connected to the grip holder by compression. For this purpose the bolts, provided the grip holder has a grip shoe, are inserted into recesses of the grip shoe. The bolts are then compressed under high pressure so that they fully fill the recesses, generally round holes, in the grip shoe. During the compression a bolt cap may also be formed which protrudes from the holes in the grip shoe and has a thicker part at the top, thereby creating an additional (form-fitting) connection with the grip shoe.

The invention also relates to a method for producing a smoothing trowel, which comprises the following steps:
a. providing a smoothing board with an upper side and a working side
b. providing a grip holder
c. providing bolts
d. producing at least one hole in the smoothing board
e. inserting the bolt into the hole
f. welding the bolt from the working side.

The steps are preferably carried out in the order in which they are listed. A hole can be produced in the smoothing board by a cutting process, in particular by drilling. The hole can also be produced by punching. For the plurality of bolts an identical number of holes (or general recesses) are provided. It is advantageous if these are produced in a single step.

It is usually very helpful to equip the grip holder with at least one bolt before welding, preferably with all the bolts to be welded. After inserting the bolts into the respective holes it can be useful to provide them with a holder there. The holder can stabilize the bolt in the correct position for welding. After welding the holder can be removed. There are a number of different aids that can be used as holders. A mechanical holder can also be used to temporarily support the bolts in a suitable manner, for example by supporting them from the upper side of the smoothing board. (The upper side is the side opposite the working side.) The grip holder itself can be used as a holder in this method step.

It can be generally advantageous to weld the bolts from any direction. However, it is particularly advantageous, to weld the bolts from the direction of the working side of the smoothing board. It is generally advantageous in methods for producing smoothing trowels if the direction in which the bolts are fed and the direction from which they are welded are opposite one another. For example, the first direction (feed direction) can be in a first hemisphere and the second direction (direction of approach of the welding device) can be in a second hemisphere and both hemispheres are opposite one another arranged about a central axis. For example, the first direction (feed direction) can be in a first straight circular cone and the second direction (direction of approach of the welding device) can be in a second straight circular cone and both circular cones are opposite one another arranged about a central axis, so that they form a double cone. Both circular cones can have a center angle of 90° or less.

It is perfectly possible for the bolts to protrude by a certain distance beyond the smoothing board. However, this distance is usually much less than the bolt length. Thus if a plurality of bolts are used, in particular more than four bolts, and the bolts are arranged closer to one another than 5 cm apart, in particular also closer than 3 cm or 2 cm, it is easier to weld bolts from the working side. On the upper side of the smoothing board, the protruding bolts would hinder the free approach and movement of a welding device or welding torch.

It can be particularly useful if the in the method the grip holder is firstly fitted with bolts and the bolts are then provided together with the grip holder. In a following method step, the grip holder together with the bolts would then be transported to the welding site. By preparing the grip holder accordingly, the welding process itself can be completed more quickly. This is advantageous, particularly if the welding devices used are expensive and a high throughput at the welding station is advantageous.

It is particularly useful if the welding of the bolts is performed by laser welding.

It is advantageous if the bolts used protrude beyond the working side of the smoothing board and bolt material is removed there during the welding process. In particular, it is advantageous if bolt material is moved into the gap between the bolt and hole. For this purpose material can be melted. Hereby all of the material protruding over the working side or only some of it can be displaced. In this way, the hole, which has to be at least minimally larger than the bolt circumference, is completely or partially closed. The displacement of material can be facilitated by the effect of gravity if the bolts are oriented accordingly. Therefore, it is advisable of the bolt ends point upwards.

The closing could be carried out by using a welding filler, for example a welding rod, however in the context of the present invention, welding without welding filler is preferred. The welding process without welding filler is even more economical and faster.

A bolt protrusion is not advantageous in itself and in this respect this method concept is not intuitive. Nevertheless, it has proved to be advantageous in the context of the present invention to accept the occurrence of a bolt protrusion in the corresponding method step.

A method is also advantageous in which at least two or all of the holes to be provided in the smoothing board are produced in one working step.

The method should be understood in relation to the smoothing trowel according to the invention. This means that features of the design of the product should be transferred analogously to the method and features of the method should be transferred analogously to features of the product.

Further features and also advantages of the invention are specified in the following drawings and the associated description. In the figures and in the associated descriptions, features of the invention are described in combination. However, these features can also be included in other combinations of a subject-matter according to the invention. Each disclosed feature is therefore also to be regarded as disclosed in technically meaningful combinations with other features. The figures are slightly simplified and schematic in part.

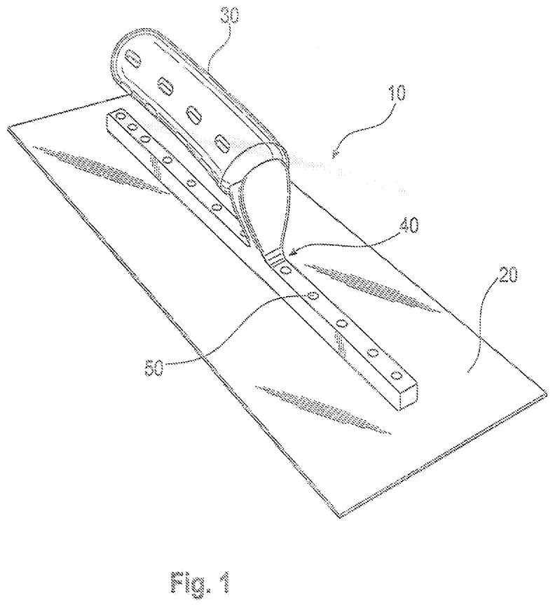

FIG. 1 shows a perspective view of a ready-to-use smoothing trowel according to the invention.

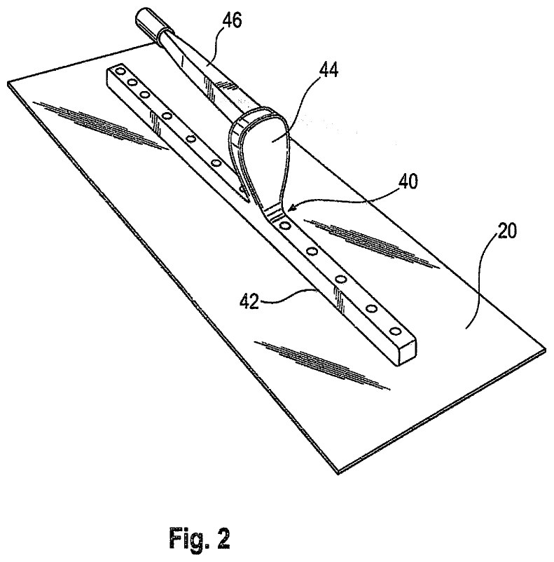

FIG. 2 shows in the same perspective view a smoothing trowel according to the invention with the handle removed.

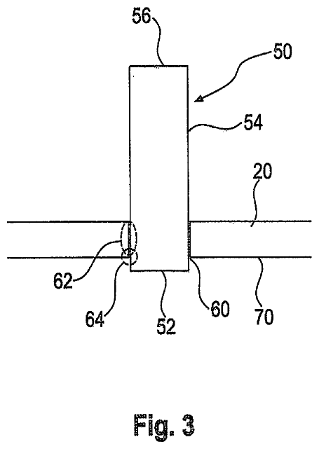

FIG. 3 shows a cross-sectional view of a bolt inserted through the smoothing board.

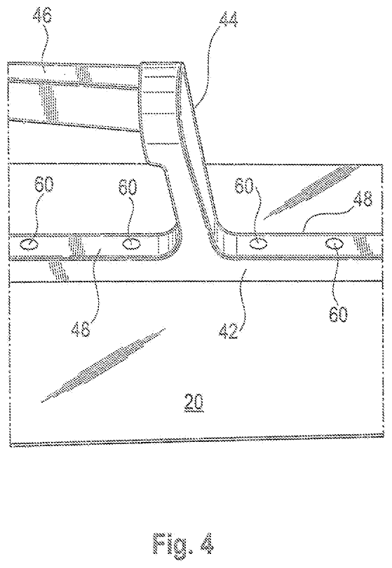

FIG. 4 shows an enlarged perspective view of a section of the smoothing trowel according to the invention.

FIG. 1 shows a smoothing trowel according to the invention in perspective view. The smoothing trowel 10 has a smoothing board 20, which is guided by the handle 30. The grip holder 40 is used to connect the handle 30 and smoothing board 20. The grip holder 40 is connected to the smoothing board 20 by a plurality of bolts 50.

FIG. 2 shows in the same perspective view a smoothing trowel 10 according to the invention, but with the handle 30 removed. This makes it easier to recognize the design of the grip holder 40. The grip holder 40 comprises the grip shoe 42. The grip shoe rests directly on the upper side of the smoothing board 20. (It is also possible to consider indirect contact by providing an intermediate layer.) It extends over a substantial portion of the length of the smoothing board, preferably over more than 50% of the length, typically between 50 and 80% of the length of the smoothing board. The grip shoe 42 is connected to a grip shaft 44 extending up from the grip shoe 42. The grip shaft 44 provides the connection to the grip core 46. The grip core 46 is preferably a rod or tube section. It has substantially the length of the handle 30. The grip core 46 can have a profile, for example a quadratic or rectangular profile, which prevents the handle from rotating about the longitudinal axis of the grip core 46. A quadratic profile is depicted here. For example, a thread can also be provided at the end of the grip core, by which the handle 30 can be secured by a nut in order to prevent it from slipping off the grip core 46.

FIG. 3 shows a schematic representation of the connection between a bolt 50 and the smoothing board 20. The bolt has a lower end 52, a bolt shaft 54 and the bolt head 56. The recess 60 is provided for the bolt in the smoothing board 20. In the case of a round bolt this recess is preferably provided as a round hole. The recess can be produced by drilling or punching.

The lower bolt end 52 is pushed all the way through the recess 60 from the upper side of the smoothing board 20. Therefore, the lower bolt end 52 of the bolt 50 protrudes and projects over the working surface 70 of the smoothing board 20.

This positioning of the bolt differs greatly from known connection types. It is typical for the welding that the bolt is placed on the upper side of the smoothing board 20. This variant therefore does not require any recess at all. In principle, a form-fitting connection would also be conceivable. The lower bolt end 52 could have a thickened part for this purpose and an area of the recess could have a corresponding widened part. However, this approach was investigated in more detail and proved to be disadvantageous, particularly with regard to its durability. In particular, if a smoothing board of low thickness is used, a stable connection can be produced initially but this connection does not remain stable over the period of use. As the trowel board is subjected to pressure during use and regularly bends, such a mechanical connection is subject to high stress. It can happen that the connection then quickly comes apart. In addition, it usually happens that the connection is no longer completely flat. In individual cases the bolt end then protrudes over the working side 70 of the smoothing board 20 or retracts behind it. In one case, a protrusion is created, in another a hollow is formed. Both have such a negative effect on the smoothing result that the smoothing trowel usually has be removed from service.

In the context of the present invention however, the bolt 50 is guided through the recess 60 in the smoothing board, in order to provide a weld joint. Such a weld joint can be provided in the first weld area 62. This weld area is located in the gap between the walls of the recess 60 and the outer circumference of the bolt 50, entirely or substantially between the upper side and working side of the smoothing board 20. If necessary also a welding filler can be used for welding. Alternatively or additionally, welding can take place in the second welding area 64. This welding area is located in the outlet area of the bolt.

Welding therefore takes place directly on the working side 70 of the smoothing trowel 20. Typically, a welding seam extends annularly along the edge of the recess and thus also in a ring around the bolt. In the case of a round hole, this produces in a round ring. Welding can be carried out with the aid of a welding filler. Alternatively, it can also be carried out without a welding filler. It may be advantageous to melt off some of the bolt material, in particular parts of the protruding bolt material, and use it to form a weld seam.

In this way, a very secure and durable connection can be formed between the bolt 50 and the smoothing trowel 20.

A connection with the grip holder 40 is produced with the area of the bolt protruding on the upper side of the smoothing trowel 20 essentially the bolt shaft 54. For this purpose, the bolt shaft 54 is guided into corresponding holes or recesses of the grip holder, typically the grip shoe 42. The connection can be provided by screwing. It would then be necessary to provide a thread on the bolt shaft 54. The connection can also be formed by pressing in. In this case, sufficient pressure is exerted on the bolt from the direction of the bolt head 56 that it fills a correspondingly dimensioned recess in the grip holder. A softer bolt material, for example aluminum, should be provided for the purpose of pressing in.

FIG. 4 shows in an enlarged section how the connection can be formed between the smoothing board 20 and the grip holder 40. As depicted, a plurality of bolts 60 are connected to the smoothing board 20. Generally, within the context of the present invention it is useful to have a number of two to twelve bolts. The bolts are connected to the smoothing board 20 at regular or variable intervals. The bolts are then inserted into suitable recesses in the grip holder 40, preferably in the grip shoe 42. Bolts are shown which have been pressed in. Thus it is not necessary to provide nuts on the upper side of the bolts 60. It is advantageous if the upper side 48 of the grip shoe 42 is ground off after pressing in. This produces a flush finish of the bolts 60 with the upper side 48 of the grip shoe 42.

Overall, it can be seen how a useful device suitable for mass production can be produced an inexpensive manner and can be used universally.

### LIST OF REFERENCE SIGNS

10 smoothing trowel
20 smoothing board
30 handle
40 grip holder
42 grip shoe
44 grip shaft
46 grip core
48 upper side grip shoe
50 bolt
52 lower bolt end
54 bolt shaft
56 bolt head
60 recess
62 first welding area
64 second welding area
70 work surface

1. A smoothing trowel (10), which comprises a smoothing board (20) and a handle (30) and in which a grip holder (40) connects the handle (30) to the smoothing board (20), wherein the grip holder (40) is connected by a plurality of bolts (50) to the smoothing board (20) by weld joints, characterized in that recesses (60) are provided in the smoothing board (20) and the bolts (50) are guided into these recesses (60).

2. The smoothing trowel (10) according to the preceding claim, wherein weld joints are providing on the working side of the smoothing board.

3. The smoothing trowel (10) according to any one of the preceding claims, wherein weld joints are provided in the region of the recesses.

4. The smoothing trowel (10) according to any one of the preceding claims, wherein the weld joints are formed by laser welding.

5. The smoothing trowel (10) according to any one of the preceding claims, wherein the smoothing board (20) is made from chromium-molybdenum steel.

6. The smoothing trowel (10) according to any one of the preceding claims, wherein the bolts (50) are guided in feedthroughs of the grip holder (40) and pressed in there.

7. The smoothing trowel (10) according to any one of the preceding claims, wherein all of the bolts (50) have the same diameter.

8. A method for producing a smoothing trowel (10), which comprises the following steps:
a. providing a smoothing board with an upper side and a working side
b. providing a grip holder
c. providing bolts
d. producing at least one hole in the smoothing board
e. inserting the bolt into the hole
f. welding the bolt from the working side.

9. The method for producing a smoothing trowel (10) according to the preceding claim, wherein at least one bolt is provided together with the grip holder.

10. The method for producing a smoothing trowel (10) according to claim 8, wherein the welding of the bolt is performed by laser welding.

11. The method for producing a smoothing trowel (10) according to claim 8, wherein the bolt protrudes over the working side of the smoothing board and bolt material is displaced in the welding process into a gap between the bolt and hole.

12. The method for producing a smoothing trowel (10) according to the preceding claim, wherein a projection of the bolt over the working side of the smoothing board is removed.

13. The method for producing a smoothing trowel (10) according to claim 8, wherein at least two holes are produced.

14. The method for producing a smoothing trowel (10) according to any one of claims 8 to 13, wherein the direction from which welding takes place is opposite the direction from which the bolts are fed.

15. The method for producing a smoothing trowel (10) according to claim 9, wherein the welding of the bolt is performed by laser welding.

16. The method for producing a smoothing trowel (10) according to claim 9, wherein the bolt protrudes over the working side of the smoothing board and bolt material is displaced in the welding process into a gap between the bolt and hole.

17. The method for producing a smoothing trowel (10) according to the preceding claim, wherein a projection of the bolt over the working side of the smoothing board is removed.

18. The smoothing trowel (10) according to claim 2, wherein weld joints are provided in the region of the recesses.

19. The smoothing trowel (10) according to claim 2, wherein the weld joints are formed by laser welding.

20. The smoothing trowel (10) according to claim 2, wherein the smoothing board (20) is made from chromium-molybdenum steel.
